(19) United States
(12) Patent Application Publication
(10) Pub. No.: US 2004/0078345 A1
(43) Pub. Date: Apr. 22, 2004

(54) Apparatus and method for account settlements between owners of software, electronic data, and remote services rented by users for processing information

(76) Inventors: Leo L. Matveev, Minsk (BY); Alex Akimov, Bobruisk (BY)

Correspondence Address: Patent Law & Venture Group, Suite K-105, 3151 Airway Ave., Costa Mesa, CA, 92626, US

(21) Appl. No.: 10/664,496

(22) Filed: Sep. 16, 2003

(30) Foreign Application Priority Data
Jan. 31, 2002 (WO) PCT/EA02/00001

(51) Int. Cl. G06F 17/00

(52) U.S. Cl. 705/400

(57) ABSTRACT

A method for account settlements between owners of software, electronic data, remote services rented by users and subjects interested in processing and/or receipt of information includes at least one program module. It operates in different communication and computer networks, for example, local area networks, the global networks such as the Internet. To regulate the process of settling accounts, all prices set for rented objects as well as for processing and/or providing information are brought into accord with unified conventional units. Control and record keeping of operations of users while working with information is provided. All actions performed by a user are also valued in conventional units. Deferred receipt, displaying and transfer of information is provided. Information is displayed according to specified parameters, which allows a user to process information in both online and offline modes.

### RELATED APPLICATION

This application claims priority and is entitled to the filing date of PCT application Ser. No. PCT/EA2/00001 designating the United States of America and filed Jan. 31, 2002 with a priority date of Mar. 16, 2001, and entitled “Apparatus and Method for Account Settlements between Owners of Software, Electronic Data, Remote Services Rented by Users and Subjects Interested in Processing and/or Receiving Information.” The contents of the aforementioned application are incorporated by reference herein.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

The present invention relates to a method for account settlements between owners of rental objects and subjects interested in processing and/or receiving information by means of an apparatus representing a program module. The invention also relates to methods for controlling and keeping record of operations with information performed by a user in exchange for using rental objects.

2. Background of the Invention

As a rule computer users use a variety of software programs to assist them in their daily work and play. Typically, users purchase software programs for use on their home or office computer. Familiar software programs can include, for example, word processing applications, data spreadsheet applications, computer games, etc. Recently there is also a tendency to purchase other types of data in electronic form designed for use on a computer. For example, MP3 files, video files, files with texts of books, etc. Moreover, a user can work with electronic data not only on his home or office computer. An example of such devices is a mobile telephone that supports Wireless Application Protocol designed for distribution of information materials via the Internet. Besides, various services that operate on remote devices and provide users with a wide range of services also enjoy wide popularity. For example, telephone calls over the Internet, access to diverse information resources, etc.

The use of computer programs and other electronic data, remote services require a certain sum of money from a user. However, sometimes it is necessary to work with a particular software program or electronic reference book within a limited period. For example, a business may require using a tax application only during its year-end tax return preparation. Likewise, a user may desire to play a particular computer game only for a few hours. In such cases it is unlikely that a user will desire to purchase said software programs, even if they are not so expensive.

The unwillingness to spend money to no purpose results in that a user cannot try several computer programs of one class at once in order to choose the most quality implemented one. As a rule there are demo or lite versions of software programs which are provided for a trial use. However, they do not provide all capabilities of professional versions. The acquaintance with capabilities of a program only by means of advertising information may result in the purchase of a software product that does not quite satisfy a user's needs. Having found later more quality implemented software product of the same class, only certain part of users will desire to purchase anything again.

Therefore recently there is a tendency to migrate from sale of electronic data, software programs, etc. to their rental. In this case a user may use a software program or access an information resource during certain period of time. However this method is not always efficient. It is explained by the fact that in most cases it is necessary to pay a fee for the use of rented electronic data or services operating on remote devices. Moreover, existing methods of payment frequently require credit card information from a user. This information stored on remote resources is not always effectively secured and can be stolen. This fact also stops many users from purchasing electronic data or using services. Besides, some users have no credit card at all.

At present there are well-known methods for distributing, in particular, computer programs that allow a user to use these software programs without payment. Moreover, one of conditions of their use is to process advertisement programs, for example, advertising banners. Such programs are referred to as “adware” and they allow their owner or developer the option of obtaining a fee from the advertiser placing his advertisements in the adware program. Such programs connect periodically to an advertising server in order to receive new advertising information and display it to a user. Adware programs enjoy popularity among users, because their use does not involve the payment of a fee. The amount of fee received by a developer of adware may depend, for example, on the amount of advertisements (banners) displayed in the program or on the amount of clicks on banners. However, software products that do not require the connection to the Internet are not included in lists of adware. It also concerns such useful and inexpensive products as calculators, etc.

At present there are also well known methods that includes paying a fee to users who process advertising information while working on the Internet. A software module is downloaded to a user's device and when the connection to the Internet is established, this module displays advertisements for processing. A user receives a driblet of money for viewing and processing advertisements, even if a user spends plenty of time on it. Therefore, this fee is a weak incentive to attract attention of users to advertising.

### SUMMARY OF THE PRIOR ART

The method for providing electronic advertising wherein an advertising module interacts with a particular software program without changing its source code was chosen as a prototype. The method allows a software developer to present advertisements built in a software product [Patent WO 99/52056, international class G06F 17/60]. The method includes:

an advertisement module attached to a software program and connected to a remote server,

the advertisement module retrieves advertisements,

displaying retrieved advertisements to the user during the use of the software program,

the developer of software program adjusts the mode of displaying advertisements to the user,

billing to an advertiser to pay a fee to the software developer for advertising information processed by a user while working with said software program,

displaying advertising information to a user between communication sessions with the Internet,

using idle time while working with the Internet for accessing an advertisement server and caching a collection of advertising banners.

The method of the patent WO99/52056 is designed to be embedded in computer programs of particular developers. It results in that the search for said computer programs situated on specialized Internet sites demands great efforts from a user. Moreover, the disadvantage of the patent WO99/52056 is the restriction of the list of products provided for a free use only by computer programs. It means that the method from WO99/52056 does not provide a user with the capability to choose other electronic data for free use, for example: video files, MP3 files and fictions. The method of the patent WO99/52056 is not aimed at providing free services situated on remote devices. For example, conducting telephone calls using Internet technologies, access to diverse information sources, etc.

Another disadvantage of the patent WO99/52056 is that the type of information provided to a user is limited only to advertising banners. Moreover, banners are displayed while a user work with a computer program. It distracts a user from his work and may results in that the user either ignores advertisements or refuse to use a computer program. A further disadvantage of the patent of WO99/52056 is that the mode of processing advertising information requires an indispensable connection to the Internet, for example, for viewing web pages of interest to a user that are associated with a corresponding advertising banners. This fact not only distracts a user from the work, but also prevent from retrieving web pages in an optimal mode (for example, communication lines are not so overloaded at night).

The described above disadvantages limit the amount of prospective users of a free computer program and, accordingly, hinder its commercial success. Besides, the advertiser is not interested in paying for advertising information ignored by a user and it also hinder the commercial success of the product. All that results in that the developer of a computer program often does not receive remuneration corresponding to the efforts for its creation.

The method for attracting attention of users to advertising information by paying a fee for its processing has also been chosen as a prototype. [U.S. Pat. No. 5,794,210, international class G06F 17/60].

The method includes displaying advertising information to a user according to a profile of each user. A user profile is based on user preferences and subjects of advertising information of interest to a user. The invention involves the use of this method in distributed computer networks such as the Internet. The invention involves the payment of fee representing compensation for processing advertising information.

The disadvantage of the patent U.S. Pat. No. 5,794,210 is that the type of information provided to a user for processing is limited to advertising information. Moreover, if a user is interested in receiving adverting information from a remote resource, he has to interrupt, for example, his surfing on the Internet. Also, the patent U.S. Pat. No. 5,794,210 does not allow receiving advertising information from a remote resource in the optimal mode (for example, at night when communication lines are not so overloaded) and adjust parameters for its optimal displaying.

The patent U.S. Pat. No. 5,794,210 involves paying a fee to a user for processed advertising information. Moreover, a user receives a driblet of money for processed advertisements, even if a user spends plenty of money on it. Therefore, this fee is a weak incentive to attract attention of users to advertisements. Those users who are satisfied by this fee (poor population of developing countries) face problems with receiving this fee.

The invention U.S. Pat. No. 5,794,210 does not envisage the possibility of providing a user with any service (for example, using computer programs or Internet services) in exchange for processing advertising information. This fact reduces the interest in advertisement processing among the users who are not interested in receiving a fee for it, but ready to process advertisements in exchange for, for example, viewing video files or playing computer games.

### SUMMARY AND OBJECTS OF THE INVENTION

An apparatus for account settlements between owners of software (S), electronic data (ED), remote services (RS) rented by users and subjects interested in processing and receiving information is a program module which performs the following operations:

converting the cost of RO as well as the cost of information to be processed and/or to be provided by a user into CU,

converting the cost of a user's actions with RO into CU,

recording, accumulating, transferring, controlling and keeping record of information received, processed and/or provided by a user as well as adjusting parameters of displaying received information,

increasing the amount of CU for processed an/or provided information by a user and authorizing the use of RO if a user has a sufficient amount of CU,

decreasing the amount of CU for the use of RO and preventing the use of RO if a user has not a sufficient amount of CU.

The apparatus comprises at least one program module designed for performing particular operations. Moreover a information accumulation program unit (IAU) is used for recording and/or accumulating information to be received, processed and/or transferred to a remote device as well as for adjusting parameters of displaying received information. A data storage program unit (DSU) is used for storing information about the amount of CU which a user has. MCPI is used to increase the amount of CU in DSU for processed and/or provided information by a user. MCPI retrieves from IAU information which has been received from a remote device and is to be processed by a user and/or transfers information provided by a user to IAU.

A program module for controlling and tracking the use of rented objects (MCRO) is used for authorizing the use of RO. MCRO decreases the amount of user CU in DSU for the use of RO and launches MCPI in case of the absence of CU.

A method for account settlements between owners of software, electronic data, remote services rented by users and subjects interested in processing and/or receiving information includes transferring information about RO by their owners to a remote device and transferring data on information to be processed and/or requests for information from subjects interested in processing and/or receiving information.

The present method involves the use of an apparatus for account settlements which comprises at least one program module that allows:

converting the cost of RO as well as the cost of information to be processed and/or to be provided by a user into CU,

converting the cost of a user's actions with RO into CU,

recording, accumulating, transferring and keeping record of information received, processed and/or provided by a user as well as adjusting parameters of displaying received information,

increasing the amount of CU for processed an/or provided information by a user and authorizing the use of RO if a user has a sufficient amount of CU,

decreasing the amount of CU for the use of RO and preventing the use of RO if a user has not a sufficient amount of CU.

Information processing causes a user renting RO to select any of available types of information provided by a remote device. Moreover, parameters of displaying information to be processed by a user are adjusted: displaying information during a work session with RO; after its receipt; within a particular period. The step of adjusting parameters for displaying information to be processed includes specifying a time interval during which a user will process information and/or specifying rules for warning a user about the need of view said information. The information display rules set by SR have a priority over the information display rules set by a user. Moreover, when a specified time interval expires, information which has not been displayed is removed.

A user processes information in online and offline modes. Moreover, if the connection to a remote device that provides RO (offline mode) is not available, a request is recorded to receive said information when the connection to a remote device is established. If the connection to a remote device is not available, all information to be transferred by a user to SR in response to a request is also recorded for further transfer to a remote device, when the connection to it is established.

Alternatively, a mixed method of payment for the use of RO is used. In comparison with existing analogues the present invention has a number of advantages among which we can emphasize the following:

a rented objects can be not only software product, but any other electronic data as well as services operating on remote resources,

a user chooses a method of use of rented objects as well as any available type of PI; prices expressed in CU is defined for each rented objects and method of its use as well we for each type of PI and processing technique,

the operations of adding CU for processing PI and writing off CU for use of RO are carried out with one account, which is very convenient. By analogy, there is no need for buy separately great amount of ingredients in order to make a sandwich, it is enough to order a sandwich,

a user can process information both during work with a rented object and in a specified period of time; moreover information is processed both in online and offline modes,

a deferred receipt, displaying and transfer of PI according to specified rules.

The above-described advantages will allow users to choose RO in centralized way and use them without payment. Moreover, the can compare the functionality of great number of RO. It will result in the fact that quality-implemented products will enjoy wide popularity and will be valuated higher. In its turn, it will contribute to the growth of interest of RO developers to the implementation of more advanced products, which will finally facilitate progress in this field.

It is an object of the present invention to increase the efficiency of the method for renting software (S), electronic data (ED) and remote services (RS) in exchange for processing and providing information by a user. An additional object of the invention is to control and keep record of information processed by a user and to settle accounts between owners of S, ED and RS and subjects interested in processing and/or receiving of information. These objects are attained by:

providing a user with the possibility to select any of available types of information, methods and modes of information processing,

accomplishing operations while working with information both during a work session with S, ED and RS and during a specified period of time,

accomplishing operations while working with information both in online and offline mode,

increasing the efficiency of account settlements between owners of S, ED and RS and subjects interested in processing and/or retrieving information by means of brining all prices for use of S, ED and RS and also prices for information processing by a user into accord with unified conventional units.

General Positions and Definitions

The following items are used as software (S) and/or electronic data (ED) and/or remote services (RS) which are hereinafter referred to as rented objects (RO) and these shall be referred to collectively and non-exhaustively as “rented objects”:

any software product, for example, word processing applications, data spreadsheet applications, computer games, etc,

any electronic data, for example, MP3 files, video files, files with texts of books, electronic messages, etc., designed for use both on a computer and other user devices. For example, mobile telephones using Wireless Application Protocol (WAP) designed for distribution of information materials via the Internet,

any cervices functioning on remote devices and providing a user with a wide range of services, for example, telephone calls using Internet technologies, the access to diverse information resources, etc.

A processing information and/or information provided by request which are hereinafter referred to as a processing information (PI) is electronic information to be processed by a user (for example, advertising information, electronic questionnaires) and also electronic information requesting by subjects who are ready to pay a user for its provision (for example, analytical materials, articles, etc.).

Subjects that provide information for processing and/or requesting information who are hereinafter referred to as SR include:

advertisers who provide electronic advertising information (banners, electronic letters, etc.) for processing,

agencies interested in receiving information from a user in the form of processed (completed) questionnaires in electronic form, diverse analytical materials, etc.,

online information resources interested in receiving information required for filling their contents, etc.,

any other resources interested in establishment of bilateral contacts with users, for example, developers of computer programs interested in testing their products and receiving information about detected errors.

The owner of RO sets prices for his RO in conventional currency (for example, in US dollars). These prices are converted into conventional units (hereinafter CU). SR sets prices for PI he provides in conventional currency (for example, pounds sterling). These prices are converted into CU. Thus, the use of CU allows avoiding account settlements between:

owners of RO and users,

users and SR,

SR and owners of RO.

The approach also allows controlling the use of several RO rented by a user in accordance with different methods of rent.

An apparatus for account settlements between owners RO and SR which is hereinafter referred to as AS and designed for controlling and tracking the use of RO and accomplishing a number of functions such as: authorizing the use of RO, scoring user actions with RO, brining prices set by owners of RO and SR into accord with CU, etc. AS comprises at least one software module performing particular functions.

A program module for controlling and tracking the use of RO which is hereinafter referred to as MCRO, is the main module of AS. It authorizes the use of RO and manages other modules of AS. It also write off CU for the use of RO in exchange for PI.

A program module for controlling and managing PI which is hereinafter referred to as MCPI, is part of AS and designed for providing a user with PI, controlling and keeping record of PI and increasing the amount of user CU.

A data storage program unit that is hereinafter referred to as DSU, is part of AS and designed for storing information about the amount of CU which a particular user has.

A information accumulation program unit that is hereinafter referred to as IAU, is designed for a preliminary accumulation of information and displaying it to a user and/or transferring to SR. It is also optimizes operations of displaying received information in a display form in order not to slow down the work of user in online mode. IAU comprises at least one unit for information accumulation and performs particular functions. A typical embodiment of IAU comprises four units that are described below.

A program unit for accumulation of information provided by SR that is hereinafter referred to as IAUSR. This unit is used for a preliminary accumulation of information provided by SR and intended to be processed by a user. The unit stores all information which processing is of interest to SR. For example, advertising banners, files in any format containing advertising materials, different questionnaires and requests for information.

A software unit for accumulation of information to be transferred to SR which is hereinafter referred to as IAUT. The given unit is used for a preliminary accumulation of information to transferred from a user to SR in response to a request. This unit stores, for example, questionnaires completed by a user, analytical materials requested by SR, information about errors detected in software, etc.

A software unit for accumulation of information received in response to active actions which is hereinafter referred to as IAUAA, is used for preliminary accumulation of PI received in response to active actions with PI provided by SR (clicks on advertising banners, web links in text of web pages, etc.). In other words, IAUAA stores, for example, web pages corresponding to banners clicked by a user.

A software unit for accumulation of nonreimbursable information which is hereinafter referred to as IAUNI is used for increasing the convenience of user work and the accumulation of the information which does not envisage payment for processing. For example, web pages retrieved by links appeared in text of web pages paid by SR and viewed by a user. Thus, IAUNI allows accumulating any additional information of interest to a user.

### BRIEF DESCRIPTION OF THE DRAWINGS

The accompanying drawings illustrate the present invention. In such drawings:

FIG. 1 shows a computer system in which the present invention operates;

FIG. 2 shows a method for renting objects to a user for the use on a local or remote device;

FIG. 3 shows an apparatus for account settlements between owners of rental objects and subjects interested in processing and providing processing information;

FIG. 4 shows an algorithm of the operation of an apparatus for account settlements; and

FIG. 5 shows an algorithm of a deferred retrieval, displaying and/or transferring processing information.

### DETAILED DESCRIPTION OF THE INVENTION

Information processing on a computer includes operations that are often referred to in terms such as adding, calling, receiving, transferring, comparing information, etc. which are often associated with manual operations performed by a human operator. The operations described herein are machine operations performed in conjunction with various input provided by a human operator or user that interacts with the computer. At first the operating environment of the present invention is described, then the method for account settlements between owners of RO and SR and finally the apparatus for account settlements.

Description of an Operating Environment of the Invention

The present invention represents an apparatus and a method for account settlements between owners of RO and SR. The present invention also represents a method for controlling and keeping record of PI processed by a user in exchange for a free use of RO. The invention is designed to operate in a distributed computer system comprising both local and remote data storage devices. From a material point of view, a computer system wherein this invention operates represents a great number of devices (computers, etc.). Devices are managed by different subjects who are referred to as owners of RO interested in processing and/or receiving information as well as end users who rent RO.

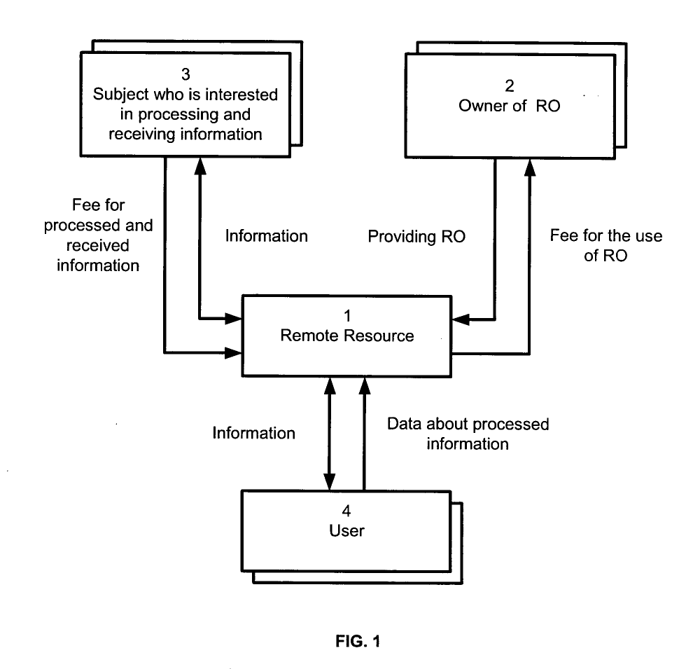

FIG. 1 shows a computer system comprising a remote resource 1 located on a remote data storage device, devices managing by owners of RO 2, devices managing by SR 3 and devices managing by users who use RO 4. The remote resource 1 located on a remote data storage device, for example, on an Internet server, receives information about RO from devices 2 managing by owners of RO whishing to rent said RO. Any software programs, for example, word processing applications, data spreadsheet applications, computer games, etc. can be used as RO. Besides any electronic data designed for using on a computer, for example, MP3 files, video files, files with texts of books, etc., can be used as RO. Moreover electronic data designed for using on user devices which differ from home and office computer (for example, mobile telephones which use Wireless Application Protocol (WAP) designed for distributing information materials via the Internet) can be used as RO. Any cervices operating on remote devices and providing a user with a wide range of services, for example, telephone calls using Internet technologies, access to diverse information resources, etc. can be used as RO. The invention allows owners of RO not only to transfer information about RO to the remote resource, but also to transfer software and/or ED to the remote resource.

The remote service 1 receives from devices 3 managing by SR data on information and/or information to be processed by a user and/or requests for information from a user. PI is may be, for example, advertising banners, electronic messages containing links to web pages with advertising materials, questionnaires with public opinion polls (for example, the determination of popularity rating of this or that politician, television program, etc.). Information processing also includes different actions which SR offers a user to accomplish, for example, viewing advertising banners (passive actions), clicking on banners in order to access web pages they advertise, effecting a purchase in shops of electronic commerce (active actions). Besides SR requests information of his interest. For example, if SR is an owner of an entertainment site, he will be interested in particular information: anecdotes and funny stories, amusing photos. If SR is a owner of an analytic agency, he will be interested in receiving analytic information of a particular subject, questionnaires of public opinion polls, etc. If SR is a developer of computer programs, he will be interested in testing said programs and receiving information about detected errors.

The remote service 1 is accessed from a device 4 managing by users to choose one or more objects to be rented. Each object which is subject to be rented, has its cost set by its owner. In its turn the cost is defined by prices for the use of RO. It means that prices for the use of each RO are determined, for example: for the use of RO during one hour, for one start of RO by a user, for the use of RO during one calendar period of time (for example, a month), for one unit of processed data using RO, for one unit of carried out actions using RO, for subscription to the use of said RO, etc. Moreover data processed by means of RO are, for example, data array indexed by means of data indexing system (prices are set for one unit of processed information—1 megabyte, etc.), indexed files (prices are set for processing of one file). The given method of processing may be mixed, i.e. it may take into account the amount and the size of indexed files, etc. The actions which were carried out using RO are, for example, the number of search operations which are carried out while working with information search and retrieval systems operating on local and remote devices. Thus, an owner of RO is paid for the use of said RO provided by this owner in accordance with its type and/or the period of its use.

The mentioned above methods of account settlements is one of few methods provided by the present invention. It should be noted that the present invention also envisages the use of methods proposed by owners of RO. To the most extent it is directed to methods for renting software. For example, in case of calculator application an owner of RO may set the number of computing operations as a method for account settlements. Since an owner of RO set himself prices, he can add to AS information on the method for account settlements he propose. In future accounts will be settled according to the method specified by the owner.

When the device managed by a user 4 accesses the remote resource 1, information to be processed and/or to be provided in response to a request of SR 3 is selected. SR pays for PI, moreover the amount of payment for said PI is defined according to the rate set by SR for each type of PI and each processing method. SR sets differential prices, for example, viewing an advertising banner is paid less than clicking on it and going to the web page this banner advertises. Prices for other information and its different methods of processing are set similarly. Thus, SR pays according to a type, amount and/or quality of PI wherein said quality is determined by a type of actions carried out on PI. The payment of PI envisages the use of correction factors which correspond to a type of information processed by a user and a method of processing. Correction factors specified for different types of information and methods of processing include; for banner advertising, viewing 0.3 and active actions 10, for advertising electronic letters, viewing 0.5 and also 10 active actions, for completing a questionnaire, 12 active actions and for provision of information by request, 20 active actions.

While selecting PI, the optimal time for processing said information is determined. Moreover, the invention involves information processing in online and offline modes. Such implementation of the invention allows performing a deferred retrieval, processing and providing information by a user in exchange for the use of RO.

Thus, a user uses RO provided by its owner and processes PI as compensation for its use. It means that the present invention allows RO owners, SR and users of RO to interact by means of the remote resource 1. An owner of RO provides information about RO. After selecting a particular RO, a user has to process and/or provide a required amount of information in order to be able to use said RO. The user receives information to be processed from the remote resource 1. He also sends there the information in response to SR request. In its turn information is provided by RS who pays for PI. The remote resource receives information about PI and the amount of money to be paid by SR is determined on its basis (for example, billing). The payment of accounts by SR involves paying a fee to owners of RO whose products have been used in processing and/or providing information.

The efficiency of account settlements between owners of RO and SR is achieved by means of bringing all prices into a unified form and these prices are expressed in CU. It means that the invention allows owners of RO and SR to set prices in their usual units of measure (any monetary unit, for example, US dollars or cents), but said units of measure are automatically converted into CU. Thus, each RO listed on the remote resource has its own cost and this cost is expressed in CU. The cost is determined for each method of RO use based on individual price table for each RO. For example, the use of a particular RO during one hour may cost 20 CU. The use of this RO during one a work session (one start) may cost 50 CU, etc. The owner of RO sets himself prices which depend on the method of use. When RO and the method of its use have been selected, the cost of licence is determined which is also expressed in CU. For example, the cost of licence for the use of said RO during 5 hours will make 20*5=100 CU. The cost of PI is determined in the same way and it depends on a type and a method of processing.

The invention includes a database which is stored on the remote resource and contains data about users and their preferences (user profiles) and data on processed and provided information by users. Information about PI is used for billing to SR, auditing processed information, etc. Data on users and information processed by them are used, for example, to display targeted information to a particular user (for example, advertising information) based on his profile. A user profile may include data beginning from simple statistics to more detailed information. The given information may contain, for example, a type of RO used by a user, data on the use of RO and data on the subject of information of interest to a user. For example, if a user often works with information on investment in a financial program, this fact may be indicated in his profile and information from this field will be retrieved and proposed him to process. If a user while processing information clicks more often, for example, banners advertising bookshop, this user will be supplied with advertisements of electronic bookshop, etc.

A self-dependent RO price management will allow an owner of RO to receive a fee that corresponds to the quality of his RO and avoid intermediaries. It also allows this owner to vary flexibly marketing policy and, thus, achieve success while promoting his products. It will contribute to the process of renting advanced technology and multipurpose software programs.

A great choice of RO provided by diverse owners permit a user to use one information resource for satisfying his requirements in diverse RO and further work with them. Moreover it is more convenient to cooperate with one service provider in the person of the owner of the remote resource than with a great number of owners and developers of RO.

A centralized accounting of all operations carried out while working with information allows accumulating CU on a user's account and to write them off for the use of RO. Such implementation allows a user to use CU, which is being accumulated for operations on information, for a simultaneous work, for example, with several objects provided by different owners of RO.

The possibility allowing a user to choose a preferred type of information to be processed, for example, advertising banners, advertising electronic letters, questionnaires contributes to the growth of interest to this information. It is also relates to the possibility to choose a method of information processing and the optimal period of time for information processing.

A free use (in exchange for information processing) of professional versions of computer programs, Internet services, etc. allows comparing the quality of their implementations, which permits a user to choose the most preferred products. Thus, the success of products (RO) will depend to the most extent on the quality of their implementation. Besides the possibility of a free use of RO allows a user to use simultaneously, for example, many computer programs, Internet resources and different electronic data (for example, MP3 files), which is not always possible in case of purchasing them.

A deferred information retrieval and processing allow a user to create a list of links (addresses) to information sources and, having set the time for their retrieval and displaying, to view them later in his spare time both in online and offline modes.

The Method for Account Settlements Between Owners of RO and SR

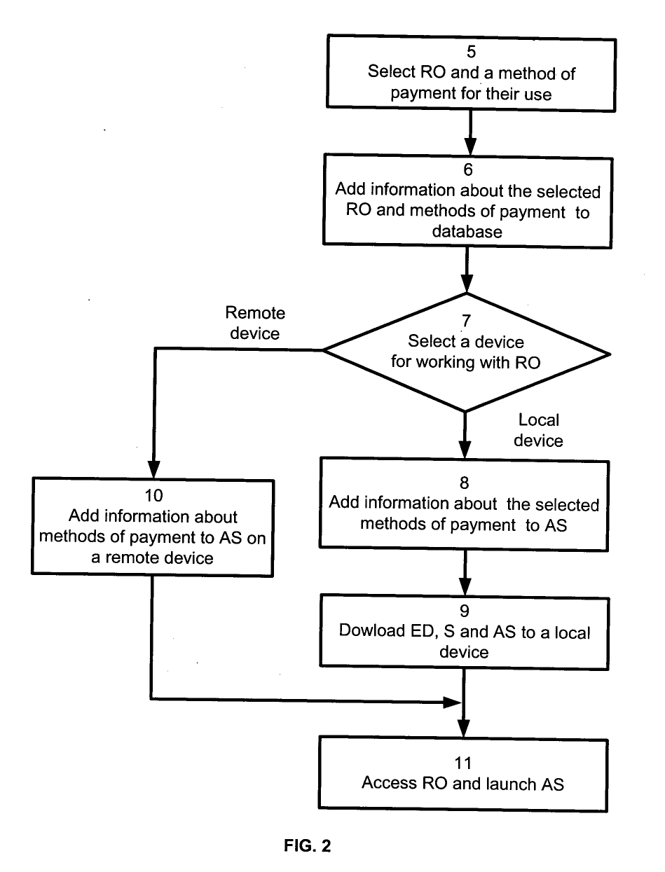

The present invention is a method for account settlements between owners of RO and SR which provides an apparatus including at least one program module. The method is implemented in the following way. Referring to FIG. 2 at step 5 the user accesses the remote resource and selects RO of his interest as well as a method for account settlements for its use. Moreover the user selects one or more RO which can be represented, for example, by MP3 files, video files, files with texts of books, software programs, an information resource operating on a remote device, etc. The user also selects a method of RO use which is preferred by any reasons for his work with a particular RO. For example, the step of selecting a method of RO use includes:

specifying an amount of hours for use of RO,

specifying an amount of RO starts,

specifying a calendar period of time for use of RO,

specifying an amount of actions carried out using RO,

specifying an amount of data processed using RO,

selecting subscriber method of RO use,

selecting a method proposed by the owner of RO for account settlements for use of RO.

Now the most widespread methods of RO use in our opinion will be described below.

A method that includes specifying an amount of actions carried out using RO, may be used, for example, while selecting a software product with a particular functional destination and a set of capabilities (operations), for example, a meta search system.

A method that includes specifying an amount of data processed using RO may be used, for example, while selecting a software product which involves processing data arrays, for example, in megabytes. An example of such software may be an archival system or word indexing system. A method of RO use which consists in specifying an amount of RO starts, is preferably applied, for example, for renting computer games, etc.

A subscriber method of RO use assumes that a user uses simultaneously several objects and in exchange for that he are ready to process and/or provide a predefined amount of information during certain period of time.

The step of selecting a method for account settlements also includes selecting types of PI and processing methods. It means that a user selects a preferred type of information to be processed and/or provided in exchange for RO use. For example, advertising banners, advertising electronic letters, questionnaires, analytical materials, etc. Moreover a user may select one or several types of information to be processed and/or provided in exchange for RO use. Later a user can change preferences and select another type or other types of information to be processed.

At step 5 the user also specifies a preferred mode of information displaying, for example, information processing during a work session with RO or in the user's spare time. Moreover the second case involves information processing without RO start. It means that if advertisements which are displayed during a work session with RO distract a user, he can set the mode causing these advertisements to be displayed, for example, before or after work with RO. Later a user may change the mode of information processing. Thus, the invention allows a user to select the optimal period of time for information processing.

Further at step 6 the user is registered (if he has not been registered yet) and his data is added to the database located on the remote resource. Said data is added to the user profile which contains, for example, information on the use of RO by the user, subjects of information of interest to the user, methods of payment for use of RO, etc.

Further at step 7 a device on which the selected RO will be used is determined. If a user selects the use of ED and/or S on a local computer, then at step 8 the information is added to the apparatus for account settlements (AS). AS allows:

converting the cost of RO as well as the cost of information to be processed and/or provided by a user into CU,

converting the cost of user actions with RO into CU,

recording, accumulating, transmitting, controlling and keeping record of information received, processed and/or provided by a user and set parameters for displaying received information,

increasing the amount of CU for processing and/or providing information by a user and to authorize the use of RO if a user has a sufficient of amount of CU,

decreasing the amount of CU for using RO and to prevent the use of RO if a user has no sufficient amount of CU.

After that at step 9 the selected ED and/or S as well as AS are downloaded to a local user device. The downloading of AS to the local device allows the user to use ED and/or S as well as to process information in offline mode. It should be noted that the downloading of AS to the local device is performed only while the user access for the first time the remote resource for downloading ED and/or S. Further AS is used as the integral part of the present method and while downloading ED and/or S or changing, for example, methods of use of ED and/or S, the information stored in AS is modified. The invention provides a user with possibility to receive new information about RO and prices for them by e-mail.

If the user chooses to use RO on a remote device, then at step 10 the information received at step 7 is added to the apparatus for account settlements (AS) located on the remote device specified by the user for the use of the selected RO. Then at step 11 the user accesses RO of his interest and AS runs too in order to authorize the use of RO and to control and keep record of PI.

The Apparatus for Account Settlements Between Owners of RO and SR

According to the implementation of the present invention the apparatus for account settlements (AS) includes one or more program units which authorize the use of RO and control and keep record of PI:

a module for controlling and tracking the use of RO (MCRO),

a module for controlling and managing PI (MCPI),

a data storage unit (DSU) containing information about the number of CU a user has,

a information accumulation unit for (IAU) is used for a preliminary accumulation of PI (it contains at least one unit).

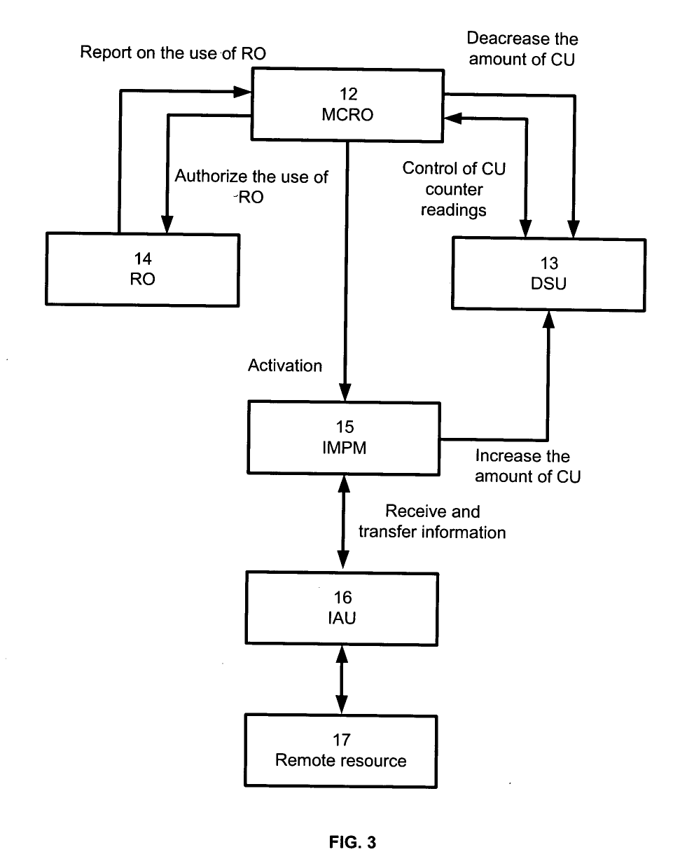

FIG. 3 illustrates the interaction of modules and units containing in AS and controlling and tracking information processed by a user. MCRO 12 accesses DSU 13 and checks the readings of CU counter. Information about CU counter reading is sent back to MCRO 12. In order to authorize the user's work with RO 14 by MCRO, the reading of CU counter stored in DSU 13 must exceed zero value and correspond to the value which is necessary for the use of RO according to the selected method. If this condition is observed, MCRO 12 authorizes the user's work with RO and decreases the amount of CU in DSU 13 for the use of RO. Moreover MCRO constantly accesses DSU to check CU counter readings.

If the user has not enough CU to use RO according to the selected method, MCRO 12 offers the user to process and/or provide information. If the user refuses to process and/or provide information, the work session with RO is terminated. If the user agree to process and/or provide information, MCRO launches MCPI 15 in order to allow a user to increase the amount of CU by processing and/or providing information. MCPI accesses IAU 16 and determines whether DSU contains information to be processed and/or provided to SR. Information from IAU is displayed to a user for processing or it is transferred to the remote resource 17 depending on a type of operations which are carried out on it. It should be noted that information which is to be displayed to the user and which is accumulated in IAU 16 is received from the remote resource 17.

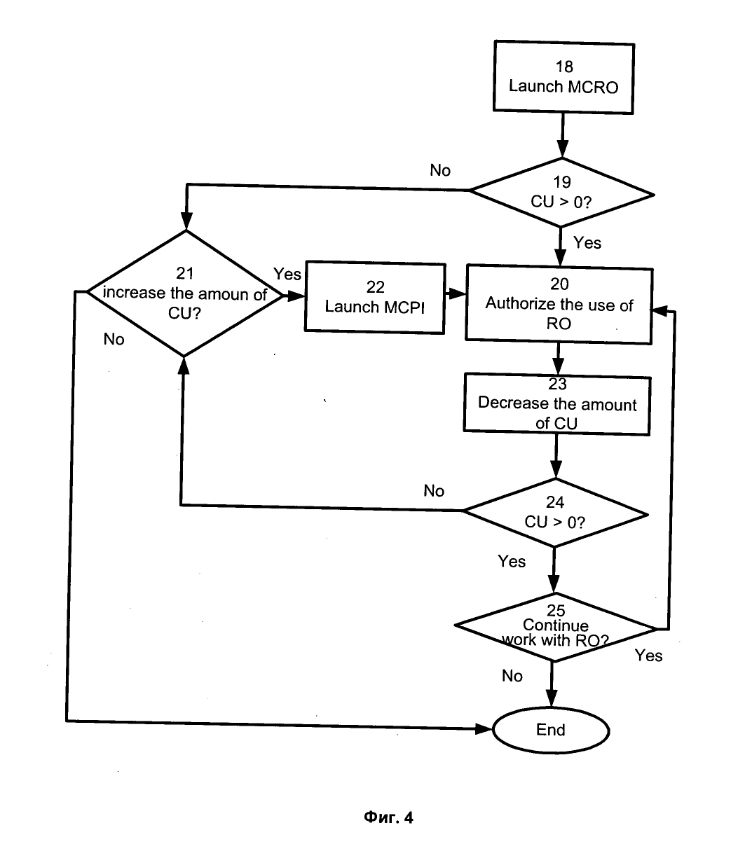

FIG. 4 shows an algorithm of operation of the apparatus for account settlements (AS). At step 18 (FIG. 4) MCPI is launched and at step 19 it accesses DSU and checks CU counter readings. If the reading of CU counter allows the user to use RO according to the selected method of rent, at step 20 MCRO authorizes the use of RO. If the reading of the counter is equal to zero, at step 21 it is determined whether the process of increasing the amount of CU will be carried out. If it does not, MCRO terminates the work session with RO. If it does, at step 22 MCRO launches MCPI for work with PI and increases the amount of CU. The invention envisages the operation of MCPI both during a work session with RO and in a specified period. For example, a user may select the mode of information processing which causes MCPI to be activated before the use of RO. Moreover, the user processes any amount of information and thus, earns CU for further work with RO. The invention informs the user about the amount of his CU in any time. When the user processes PI, MCPI increases the reading of CU counter in DSU and takes into account the correction factor which corresponds to a type of PI and its processing method. Thus, MCPI increases the reading of CU counter in DSU according to said correction factors. The invention also provides a possibility to work in online and offline modes. Before accessing the remote resource for receiving and/or transferring information, MCPI accesses IAU and checks whether there is any information to be displayed and/or transferred there. Information processing in online mode requires the connection to the remote resource to permit MCPI to request and display information to a user. It should be noted that information which is received from the remote resource or which is to be transferred there, is added to IAU. The connection to the remote resource for receiving information can be established forcedly or from time to time. A forced connection to the remote resource is established, if CU counter in DSU is equal to zero.

When a user has processed and/or provided information and CU counter reading has increased, at step 20 MCRO authorizes work with RO. At step 23 MCRO decreases the amount of CU in DSU for work with RO. Further at step 24 CU counter reading is checked and if its reading is equal to zero, the process proceeds to step 21. If CU counter reading exceeds zero value, then at step 25 it is determined whether the work session with RO is in progress. If it is, the process proceeds to step 20. Otherwise MCRO terminates the work session with RO.

If the connection to the remote resource is available, MCPI accumulates information in the information accumulation unit (IAU) in order to display it to a user between communication sessions (in offline mode). A preliminary information accumulation is also used to optimize information display in screen forms and not to slow down a user's work in online mode. IAU can store a specified data volume. This volume is determined by the amount of information units added to IAU and/or the size of information stored in IAU. IAU is filled gradually during a communication session with the Internet, moreover a user need not to activate RO. It means that IAU may be filled during any connection to the Internet, for example, while the user surfs the Internet. Moreover information is accumulated in IAU only during idle time of communication line (for example, while a user is viewing a loaded page), i.e. in the optimal mode for a user. As far as possible IAU is filled to the maximum. In case of switching to offline mode, information which has been saved to IAU, will be displayed to the user. IAU is also used for accumulating information which the user provides by request of SR. Since MCPI operates both in online and offline modes, the user can add information requested by SR to IAU in order to transfer this information to SR when the connection to the remote resource is established.

The functional capabilities of MCPI and the presence of IAU (which comprises at least one unit) allow carrying out a deferred information retrieval and displaying to a user and a deferred transfer of information requested by SR. A user can retrieve not only information that was provided by an advertiser for processing, but also any other information.

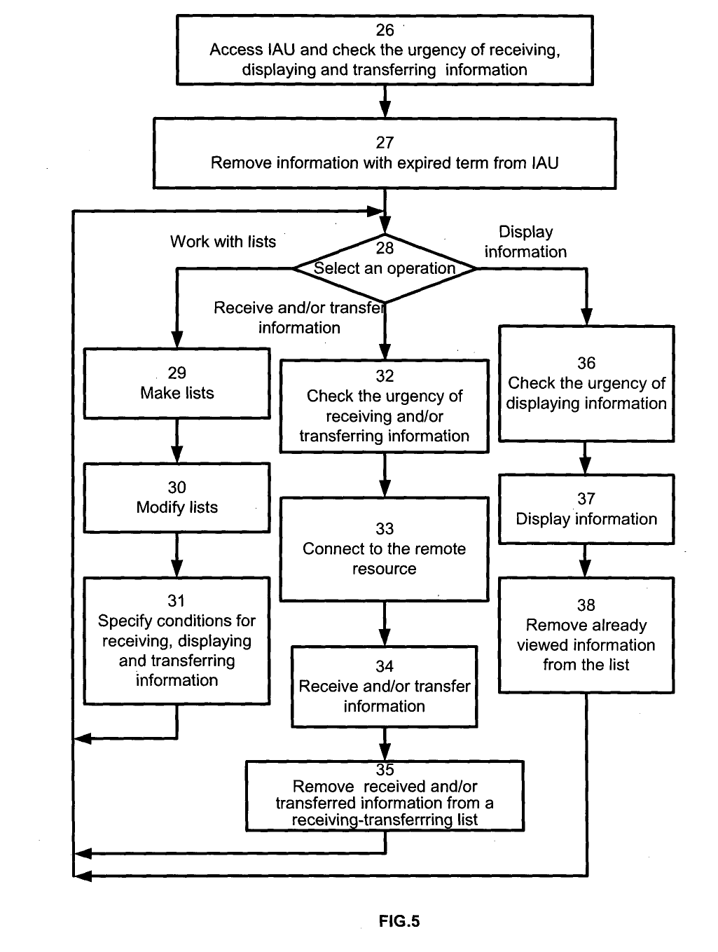

FIG. 5 illustrates the algorithm of a deferred retrieval, displaying and/or transferring PI with IAU (which includes at least one unit). Referring to FIG. 5, at step 26 IAU is accessed and the need to receive, display and/or transfer information is checked according to the specified time parameters. At step 27 PI for which the specified time interval (receiving, displaying, transferring) has been elapsed, is removed from IAU. Then at step 28 operations for further work with PI are selected. If it is determined at step 28 that the operation which includes making a list of PI for deferred receiving, displaying and/or transferring has been selected, at step 29 a list is made according to which PI will be received, displayed and/or transferred. Moreover, each PI is added to IAU. Then at step 30 the list is modified (IAU modification), it means that PI is added to and/or removed from the list. At step, 31 conditions are specified for receiving, displaying and/or transferring PI which is included in the list taking into account its modification. The deferred receipt and transfer of information will be carried out in automatic mode during the next connection to the remote resource. Moreover, the deferred receipt and transfer of information can be carried out both in background mode and priority mode. It means that a user can set priority for the deferred receipt and transfer of information and this information will be immediately received and/or transferred when the connection to the remote resource is established. Information is received in the background mode when a communication line stands idle and the connection to the remote resource is available. For example, while receiving e-mail, surfing the Internet, etc. The step of laying down conditions for receiving, displaying and/or transferring PI includes setting a priority for each entry of the list which has been made at step 30. It means that the step of laying down conditions determines what PI will be received, displayed and/or transferred first of all.

At step 31 time parameters are set for receiving and further processing PI. It means that a period of time is set for receiving and displaying PI to a user (separate parameters for receiving and displaying). For example, information can be displayed: after its receipt, in a strictly specified time (date and time), in a specified time interval during which information must be displayed according to settings of a warning system which informs about the need of displaying information. For example, the user sets a 10 day interval and adjusts settings of the warning system according to which a message advising to view received information is displayed on the screen each time a user accesses RO. After warning, said information is immediately displayed or it will be displayed later.

If it is determined at step 28 that PI will be received and/or transferred according to the set time parameters, then at step 32 the need to receive and/or transfer information is checked. It means that the need to receive and/or transfer PI is checked again before connecting to the remote service. The step of checking the need to receive and/or transfer PI may involve in case of need removing PI with expired time limit specified for receiving and/or transferring information. At step 33 the connection to the remote resource is established. Further at step 34 information is received and/or transferred. After receiving and transferring PI, at step 35 information which has been received or transferred is removed from the list for receiving and/or transferring PI.

If it is determined at step 28 that PI will be displayed according to the set time parameters, at step 36 an additional check of the need to display PI which has been previously received (saved) is performed before displaying it. The step of checking the need to display information may involves in case of need removing PI with expired time limit specified for displaying information. At step 37, information is displayed. Then at step 38 PI which has been displayed is removed from the list of information that is to be displayed.

An additional check of need to receive, display and/or transfer information is indispensable at steps 32 and 36 if a work session with the system where the present invention operates will be long and there is probability that the time interval which has been set for receiving, displaying and/or transferring PI will elapse. After performing any of steps: 31, 35 or 38 the process proceeds to the step 28.

According to the implementation of the present invention IAU includes one or more units for accumulating information:

a unit for accumulating information provided by SR (IAUSR),

a unit for accumulating information which hi to be transferred to SR (IAUT),

a unit for accumulating information received in response to active actions (IAUAA),

a unit for accumulating nonreimbursable information (IAUNI).

MCPI manages all the units which are designed for accumulating information. Each of said units is designed for accumulating corresponding PI and MCPI accesses them depending on actions. All the units of IAU are accessed concurrently.

Logic of SAUT Operation

After launch MCPI determines whether IAU contains information which the user has already processed and the transfer of this information to the remote device will result in increase in CU that a user has. For that MCPI accesses IAUT and if IAU contains PI which is to be transferred to SR, it establishes the connection to the remote resource to transfer said information. Moreover a user receives information about the amount of CU which will belong to him after the transfer of PI from IAUT to the remote resource. This information will allow the user to determine whether he will have a sufficient amount of CU for the use of RO of interest to him. CU is transferred into the user's account only after the transfer of information from IAUT and the acknowledgement of its receipt by the remote resource. After the receipt of said acknowledgement, PI which has been transferred is removed from IAUT. The amount of received CU is determined according to the type of PI transferred to the remote resource and the method of processing. IAUT is filled with information both in online mode and offline one. It means that the user can process information in any optimal time and moreover there is no need for the connection to the remote resource. All processed and completed questionnaires, analytical materials, etc. will be added to IAUT and will be put in transfer queue. The user can set a priority for the transfer of each PI which was put in queue. It is useful when the time for providing a particular PI is limited and it is critical to transfer it as soon as possible.

The logic of IAUT operation involves a deferred transfer of user information to the remote resource. For example, while processing a questionnaire of public opinion poll during election period, a user competes it in offline mode and sets the mode of deferred transfer of this questionnaire to the remote resource. This information will be put in deferred transfer queue. The deferred transfer of information includes setting foreground or background transfer mode as well as controlling the need transfer information. Moreover, MCPI will increase the amount of CU only if information is transferred in time. In case of election public opinion poll, the questionnaire which has been completed, but not transferred in time becomes useless and the amount of CU will not increase for it. It is clear that the amount of CU will not increase too if the questionnaire is completed, but not transferred at all. However, if information remains its actuality during long term, a user can transfer it in any time. It relates, for example, to those case when an entertainment web site collects different information: anecdotes, funny stories, etc. After transferring PI and acknowledging its receipt by the remote resource, this information is removed from a deferred transfer queue.

Logic of IAUSR Operation

All information which is to be processed by a user is added to IAUSR. This unit stores PI to be displayed to a user. The invention allows specifying a priority for displaying information according to which this of that information (for example, advertising banners) will be displayed first. The possibility to set a priority for displaying information is useful when prices set by SR are differentiated and the owner of the remote resource where the present invention operates is interested in displaying first the information which has been paid at a higher rate. If IAUSR contains information with the same priority, it is displayed according to the order of adding information to IAUSR.

The step of filling IAUSR with information also includes setting parameters of displaying information. Moreover parameters are set both by the user and SR. The invention includes a recurring display of information to be processed with repeat count and frequency specified in instructions which accompany information. Besides a time interval for displaying said information is set. The following mode of displaying information may be used: displaying information in a reserved area of the screen, periodically pop-up in front of the application (activated RO), taking over the entire screen, interrupting usage of the application program, etc. The number and frequency of repeats may be set by SR (for example, an advertiser) whishing, for example, that an advertising banner will be displayed several times with a specified time interval during defined period of time. If a user does not respond to said banner during the first showing, it will be displayed repeatedly according to specified parameters. The possibility allowing SR to set time interval for displaying information to a user is useful in cases when this information has a limited period of validity, for example, in case of displaying banners advertising goods with discount which is available during limited time interval (for example, holiday sales, etc.). Moreover the parameters of displaying information specified by SR has a higher priority than those specified by a user.

The invention uses a variety of methods to ensure quality processing of PI (in particular, viewing). For example, while displaying information to a user, a time interval is specified during which the information cannot be replaced by other information. Moreover this information changes when a user performs a particular action, for example, clicks on the right button of the mouse, etc. The present invention prevents a repeated downloading of the same information to IAUSR (if it is not envisaged by special instructions to a particular PI), which also contributes to the increase in the quality of processing.

Information accumulated in IAUSR can be viewed both in online and offline modes. The amount of CU to be provided for viewing PI depends on its type (banners, advertising letters, etc.). CU is provided for each entry from IAUSR viewed by a user. The amount of CU increases while viewing PI both in online and offline modes. Moreover while viewing PI in online mode, data on processed PI are transferred immediately to the remote resource. While viewing PI in offline mode, data on processed PI are transferred when the connection to the remote resource is available.

Viewed PI is removed from IAUSR, if the mode of repeated display is not envisaged for them, which can be specified by SR. If a user responds to PI, for example, clicked a banner, this banner is removed from IAUSR and added to IAUAA for further receipt of information that corresponds to it.

Logic of IAUAA Operation

IAUAA is designed for accumulation of information which will be received in response to active actions of a user with PI. IAUAA is filled in the following way. A user is viewing PI which has been accumulated in IAUSR. If a user is interested in receiving additional information, for example, to any banner or link in the text of advertising letters, a user activates said PI (a user clicks a banner or link). Moreover PI is moved from IAUSR to IAUAA and additional information will be received by means of links corresponding to said PI and will be added to IAUAA. Active actions with PI involves the mode of deferred information receipt and displaying. For example, having selected the offline mode of information processing, a user views banners and he is not interested in receiving additional information corresponding to particular banners. To receive this information in online mode, it is enough to click a banner and said information received for the remote resource will be displayed in the window of web browser. However since a user woks in offline mode and there is no connection to the remote resource, an active action with a particular banner (clicking) will result in that the link to information source corresponding to said banner will be put in a queue (a list) for deferred information receipt and further displaying. It means that the present invention provides the possibility to record a request for deferred receipt of information. The request for information in response to active actions is removed from the queue for receiving information, when corresponding PI is received from the remote resource.

A deferred display of received information may be performed both in online and offline modes. The invention allows specifying time interval during which information is to be displayed to a user. Otherwise if said time interval elapsed, information which has not been displayed is either removed or moved to a special service catalogues that is an analogue of the recycle bin in Microsoft Windows. Moreover information which has not been displayed will be removed from the list for a deferred display of information. Such possibility involves the control of need to process information. For example, a user working with RO before Christmas holiday was interested in a banner advertising a product of interest to this user in view of offered discount. After using the mode of deferred information receipt and displaying, a user received information of interest, but he decided to postpone its examination by specifying 30 day time interval for displaying information. However since Christmas discounts are in force during a limited period of time, the given information becomes quickly useless. Therefore, in this case it will be immediately removed when the term of discounts will expire. Moreover, MCPI will not increase the amount of CU, because information has not been processed. Similarly, when a user has to complete a questionnaire with public opinion poll which actuality is limited to a certain period. Such questionnaire may be, for example, an election public opinion poll, etc. Information accumulated in IAUAA is displayed according to specified parameters. Parameters of displaying may be set by SR and a user in the same way as while working with IAUSR. Moreover parameters of displaying specified by SR has a higher priority than those specified by a user. It is explained by the fact that IAUAA is designed for accumulation of information in which SR is interested.

CU is provided for processing PI received in response to active actions only if it was viewed (i.e. the receipt of information does not mean that CU will be provided for it). Moreover the amount of CU increases while viewing PI both in online and offline modes. While viewing PI in online mode, data on processed PI are transferred immediately to the remote resource. While viewing PI in offline mode, data on processed PI are transferred when the connection to the remote resource is available. If a user desires, viewed PI is removed from IAUSR

Logic of IAUNI Operation

The logic of IAUNI operation is similar to IAUAA logic. The main difference is that IAUNI is designed for accumulation of information which does not envisage payment for viewing and processing. For example, a web page contains links (including advertising banners) the processing of which does not envisage payment. If a user is interested in said links, he can use the deferred information receipt and displaying corresponding to these kinks (by means of setting parameters for receiving and displaying). Only the user can set a priority for receiving and displaying information, which is accumulated in IAUNI. Information is accumulated in IAUNI by using the mode of a deferred receipt and information display.

The present invention provides a mixed method for account settlements with owners of RO as an alternative method of RO use. The mixed method includes not only processing and/or providing information by a user, but also a partial payment as the compensation for RO use. Such approach is explained by the fact that in some cases it is preferably to pay a part of price for use of RO in order to economize time spent on information processing.

An Exemplary Embodiment of the Invention

The remote resource (Internet server) contains information about a great number of ED, S and RS to be rented. This information is received from different owners of RO which provide their product at diverse prices. This Internet server also contains information received from different advertisers who are interested in providing potential users with advertising information for processing. Moreover each type of information (banner advertising, mailing lists, etc.) its own price depending on technique of information processing (viewing, active actions).

Having accessed the Internet server, a user chooses, for example, a meta search program designed for use on local use device (computer). Moreover he chooses a method of rent for this meta search program which involves hourly pay. A user chooses advertising banners as information to process in exchange for the use of the selected software products.

The price which was set by the owner of RO for hourly pay of the given software product is $0,30 per hour. According to the present invention said price is converted into conventional units (CU). In this example 1 CU is equal to $0,01 and, accordingly, the hourly pay for the use of this meta search program will equal to 30 CU and this value is automatically added to the price table. The use has to earn this amount of CU by processing advertising information in order to use this meta search program within one hour.

In his turn an advertiser set prices for information to be processed (advertising banners). In this example the following prices are set: an advertiser pays, for example, $0.015 for viewing one advertising banner, $0,10 for one click on banner. Accordingly, in this example (1 CU=$0,01) the user gains 1.5 CU for viewing one advertising banner and 10 CU for one click one banner.

Thus in order to use the rented meta search program within one hour, the user has to gain 30 CU and, accordingly, he has to click 3 banners or view 20 banners. The user chooses a convenient mode of information processing, for example, before a work session with the meta search program in order not to interrupt work with the program. MCPI allows the user to process information in independent mode without running the meta search program. While processing banners (in online mode), the user performed active actions, i.e. he clicked banners and moved to corresponding web pages. The user clicked 6 banners of his interest, gained 60 CU and finished information processing. Besides when the connection to the remote resource is established (online mode), MCPI accumulates banners to display them to the user between communication sessions (in offline mode). While accumulating information, MCPI uses idle time of communication line and receives information from the remote resource in the mode which is optimal for the user. Having turned to offline mode, a user decides to replenish the supply of CU and runs MCPI that display accumulated banners to the user. Having been interested in other 6 banners, the user set the mode of deferred receipt of information and clicks said banners which are put in the queue for deferred retrieving and displaying. More over the user set parameters for receiving banners in background mode. Since these banners have interested the user, he set parameters for displaying which according to the present example involves informing the user that there is information to be displayed in the display queue. Any time the user will access the meta search program or MCPI, he will be informed about the availability of new information. Besides while setting parameters for a deferred displaying of information, the user has set a 10 day time interval for displaying information.

When the user connects to the Internet, for example, to receive e-mail, web pages corresponding to the banners selected by the user will be received to the user local device. The user processed (viewed) only 4 of 6 web pages. The other pages were removed from the queue for deferred displaying of information, because the user was absence during certain time and could not process them. Thus the user gained 40 CU (4 banners wee processed in the result of active actions) and in total the user gained 100 CU (60+40). When the reading of CU counter in DSU exceeds the zero value, MCRO which constantly checks readings of CU counter authorizes the use of the meta search program.

Moreover the user can use a deferred receipt and displaying not only in respect of information which envisages payment for processing. It means that the user can use a deferred receipt to receive and view any information which corresponds to any link appeared in the text of web pages received by means of banners. It is clear that the user gains nothing for viewing and processing it.

As the present invention includes also providing an administrator (the owner) of the remote resource with compensation, a correction coefficient is imposed on advertising information which is processed by the user. In this example this correction factor is equal, for example, to 0,95. It means that the user who processed advertising information valued at 100 CU, will gain just 95 CU. 5 CU will be a compensation for the administrator (the owner) of the remote resource. 95 CU will allow the user to user the meta search program during 3 hours and 10 minutes. Thus, in this example the owner of this program will gain $0.95 and $0,05 will be a compensation for the administrator (the owner) of the remote resource.

While using the meta search program, MCRO tracks its use. Moreover MCRO decreases the value of CU counter in DSUII. Thus before the beginning of the a work session with the meta search program the value of CU counter is 95, but for example, after 30 minute work with said software program, this decreases by 15 units (30 CU per hour) and, accordingly, 80 CU remain on the user's account.

The user accesses again the remote resource (the Internet server) and selects a video film for viewing on his local device. The user chooses a method of use which depends on the number of uses of RO. The price which was set by the owner of said film for its use according to the selected method is, for example, $0.10 for one use or 10 CU. When the user sees this video file 2 times, 20 CU will be written off from his account and only 60 CU will remain. Then the user may choose another RO (ED, S or RS) or spend the rest of CU for the use of the meta search program and video file.

When the value of CU on the user's account is equal to zero (for example, after several a work sessions with the meta search program), MCRO displays the message advising to process advertising information in order to continue the use of the program. If the user agrees to do it, MCPI is launched. Otherwise MCRO terminates a work session. Later on if the value of CU counter in DSU exceeds the zero value, MCRO will authorize the use of the meta search program. It means that in any case the user will have to process advertising information in order to make MCRO authorize the use of meta search program.

In case of the subscriber method of RO which assumes that a user selects several objects to rent and he is ready to process a predefined quantity of advertising information in exchange for the use of these objects during certain period of time, the method of payment will be carried out in the following way. For example, a user chooses 3 rented objects for the use according to the subscriber method: a video file, a computer program and a file with text of a book. The total cost of license makes, for example, 100 CU (this sum will be distributed among owners of the ED and S). It is possible to assume that the user will use each of the selected RO during different time interval. For example, the computer program was used 30% out of the total period of time of the subscriber use, the video files was used was used 20% and the file with book text was used 50%. Accordingly the owner of the computer program will be paid 30 CU, the owner of the video file will get 20 CU and the owner of the file with book text will gain 50 CU. Thus the amount of fee paid to owners of RO will depend on the popularity of their products.

The above-described embodiments of the present invention are intended to be examples of the present invention and alternations and modifications may be effected thereto, by those of skill in the art, without departing from the scope of the invention which is defined by the claims.

### INDUSTRIAL USE

The present invention in distributed computing systems includes a remote computing device connected by communication network to execute tasks. The invention can operate in different communication and computer networks, for example, local area networks, global network Internet, etc.

The Internet is available to all and it will allow a great number of users to use RO without payment, to choose a method of RO use and methods for account settlements for their use which include choosing a type of information to be processed am/or provided and processing technique. The invention also allows owners of RO to rent intellectual property on condition of payment for its use. Moreover, the payment will be carried out by settling accounts between owners of RO and subjects which pay for information processed and/or provided by users.

The industrial use of the present invention is defined by optimizing the process of providing users with free RO provided by different owners in exchange for processing and providing information to subjects interested in processing and receipt of said information.

The words used in this specification to describe the invention and its various embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of this described invention and its various embodiments are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments below or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptionally equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. An apparatus for account settlements between owners of rented objects, including at least one of software, electronic data, and remote services, wherein the rented objects are rented by users interested in receiving and processing information, the apparatus comprising:
a means for converting a cost of renting the rented objects into conventional units;
a means for converting a cost of user actions on the rented objects into the conventional units;
a means for recording, accumulating, transferring, controlling and keeping record of the information and of an amount of conventional units available to the users;
a means for authorizing the use of the rented objects when a user has sufficient available said conventional units;
a means for decreasing the amount of the available conventional units for the use of the rented objects; and
a means for preventing the use of the rented objects when a user has insufficient available conventional units.

2. The apparatus of claim 1 further comprising: a means for recording and accumulating the information in an information accumulation program when the information is subject to being received, processed and transferred to a remote device.

3. The apparatus of claim 2 further comprising: a means for storing information defining the amount of conventional units available to users in a data storage program.

4. The apparatus of claim 3 further comprising: a means for information management configured for increasing the amount of conventional units in the data storage program so as to enable an increase of the information processed and provided by a user; and a means for retrieving information from the information accumulation program, said retrieved information previously received from the remote device when the information is intended to be processed by a user and subsequently transferred to the information accumulation program unit.

5. The apparatus of claim 4 further comprising: a means for controlling and tracking the use of rented objects; a means for authorizing the use of the rented objects; a means for decreasing the amount of conventional units of a user upon use of the rented objects; and a means for launching the information management program when the conventional units of a user are depleted.

6. A method for account settlements between owners of rented objects, including at least one of software, electronic data, and remote services, wherein the rented objects are rented by users and subjects interested in receiving and processing information, the method comprising the steps of:
transferring information about rented objects to a remote device owners of the information,
transferring data of information to be processed by a user of the rented objects to the remote device from a subject interested in processing the information by a user, when the subject wishes to process a request for information provided by the user;
converting the cost of rented objects and information into conventional units;
converting the cost of user actions with rented objects into conventional units;
recording, accumulating, transferring, controlling and keeping record of information received, processed and provided by a user; and adjusting display parameters of received information;
increasing the amount of conventional units for processing; providing information by a user and authorizing the use of rented objects when a user has conventional units;
decreasing the amount of conventional units for using rented objects; and
preventing the use of rented objects when a user has insufficient conventional units.

7. The method of claim 6 further comprising the step of selecting available types of information provided by the remote device for processing.

8. The method of claim 7 further comprising the step of displaying information to be processed according to rules, including:
displaying information immediately during a work session with rented objects;
displaying information immediately after receipt and at any time through manual activation;
displaying information at a pre-specified time;
specifying a time interval for displaying information to be processed and the frequency of warning of a need to display said information;
establishing a higher priority for display rules set by a remote subject over information provided by a user.

9. The method of claim 8 further comprising the step of removing information that has not been displayed over a specified time interval.

10. The method of claim 9 further comprising the step of processing information in both online and offline modes as selected by the user.

11. The method of claim 10 further comprising the steps of requesting information for processing by a user; adding the information to at least one of a processing queue and a transferring queue when a connection to the remote device is unavailable.
